(19) United States
(12) Patent Application Publication
(10) Pub. No.: US 2026/0178731 A1
(43) Pub. Date: Jun. 25, 2026

(54) INPUT MITIGATION

(71) Applicant: Walmart Apollo, LLC, Bentonville, AR (US)

(72) Inventors: Aditya Venkat Kumarakrishnan, Forest Hills, NY (US); Dinesh Sardana, Wilton, CT (US)

(21) Appl. No.: 19/389,237

(22) Filed: Nov. 14, 2025

Related U.S. Application Data
(60) Provisional application No. 63/738,378, filed on Dec. 23, 2024.

(51) Int. Cl. G06F 21/55

(52) U.S. Cl. CPC G06F 21/554; G06F 21/552

(57) ABSTRACT

Example implementations relate to input mitigation for automated systems. In an example, a user input for a targeted model is received an anomaly score of the user input is determined. The anomaly score is representative of a similarity to expected inputs for the target model. In response to determining the anomaly score equal to or greater than a predetermined threshold, the user input is prevented from being provided to the target model and a mitigation process is implemented based on the user input. In response to determining the anomaly score is less than the predetermined threshold, the user input is provided to the target model and a responsive output based on the user input is generated by the target model.

### CROSS REFERENCE TO RELATED APPLICATION

This application claims benefit to U.S. Provisional Patent Application No. 63/738,378, entitled “INPUT MITIGATION,” filed on Dec. 23, 2024, the disclosure of which is incorporated herein by reference in its entirety.

### TECHNICAL FIELD

This application relates generally to input mitigation and, more particularly, to input mitigation for automated interaction systems.

### BACKGROUND

The proliferation of automated interaction systems, such as chatbots, generative systems, and conversational systems has led to a similar proliferation of malicious behavior against these systems. Intentionally malicious behaviors, such as jailbreak attempts, prompt injections, or fraudulent interactions may be intended to cause an automated system to perform operations that are outside the scope or intended use of those systems. Similarly, accidental unexpected behavior, such as off-topic conversations by otherwise well-meaning users, may similarly result in unexpected or unauthorized behavior of automated interaction systems.

Current systems rely on configurations of underlying processes, such as configuration prompts for large language models (LLMs), rules-based processes, and intent classification to attempt to mitigate these malicious behaviors. However, these current mitigation efforts are unable to adequately capture or prevent the wide range of malicious or unwanted inputs that may be received by automated systems, producing both a high number of false positives and a high number of false negatives. In addition, some malicious behavior, such as jailbreak attempts or prompt injections, are expressly designed to avoid current controls used in automated systems.

### BRIEF DESCRIPTION OF THE DRAWINGS

Various examples will be described below with reference to the following figures.

FIG. 1 depicts an example system that provides input mitigation, in accordance with some embodiments.

FIG. 2 depicts an example system for implementing a plurality of mitigation processes, in accordance with some embodiments.

FIG. 3 depicts an example system for generating an anomaly score for a user input, in accordance with some embodiments.

FIG. 4 depicts a flowchart of an example method for mitigating inputs to a target model, in accordance with some embodiments.

FIG. 5 depicts a flowchart of an example method for implementing an anomaly likelihood model for a target model, in accordance with some embodiments.

FIG. 6 depicts an example system with a machine-readable medium that includes instructions for input mitigation, in accordance with some embodiments.

FIG. 7 depicts an example system with a machine-readable medium that includes instructions for implementing an anomaly likelihood model for a target model, in accordance with some embodiments.

FIG. 8 depicts a block diagram of a computing device, in accordance with some embodiments.

### DETAILED DESCRIPTION

The disclosed systems and methods enable automated filtering of inputs to target systems, preventing receipt of unwanted, malicious, or harmful inputs before they reach the target system. As discussed in greater detail below, in some embodiments, the implementation of an input mitigation process that identifies out of distribution inputs for mitigation processing enables the input mitigation system to capture both known and unknown harmful, malicious, or unwanted inputs. The use of an input distribution for input mitigation further enables the input mitigation system to identify inputs that are specifically designed to avoid or circumvent other input mitigation processes. In addition, in some embodiments, the use of multiple mitigation processes, each tuned for a different type of potential harmful, malicious, or unwanted input, allows for input-specific mitigation operations to be performed, allowing well-meaning users to be redirected to provide expected inputs while routing malicious users to other interaction channels to prevent further harmful attempts against the target system. These and other advantages will be apparent from the disclosure herein.

This description of the example embodiments is intended to be read in connection with the accompanying drawings that are to be considered part of the entire written description. Terms concerning data connections, coupling and the like, such as “connected,” “interconnected,” and/or “in signal communication with” refer to a relationship wherein systems or elements are electrically connected (e.g., wired, wireless) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system for input mitigation is disclosed. The system includes a processor and a non-transitory memory that stores instructions. The instructions, when executed, cause the processor to receive a user input for a target model and determine an anomaly score of the user input representative of a likelihood of the input being within an expected distribution of inputs for the target model. When the anomaly score is greater than or equal to a predetermined threshold, the processor prevents the user input from being provided to the target model and implements a mitigation process based on the user input. When the anomaly score is below the predetermined threshold, the processor provides the user input to the target model and generates, using the target model, a responsive output based on the user input.

In various embodiments, a computer-implemented method is disclosed. The computer-implemented method includes steps of receiving a set of annotated (and anonymized) historical transcripts, determining a set of expected inputs for a target model based on the set of annotated historical transcripts, adjusting an anomaly likelihood determination model based on the set of expected inputs, receiving a user input intended for the target model, determining, by the anomaly likelihood determination model, that an anomaly score of the user input representative of a similarity to the set of expected inputs is greater than or equal to a predetermined threshold, and implementing a mitigation process based on the user input including preventing the user input from being provided to the target model.

In various embodiments, a non-transitory computer-readable medium having instructions stored thereon is disclosed. The instructions, when executed by a processor, cause a device to perform operations including receiving a user input directed to a target model and implementing an anomaly likelihood determination process to determine an anomaly score of the user input representative of a similarity to expected inputs for the target model. When the anomaly score is greater than or equal to a predetermined threshold, the instructions cause the device to perform operations including preventing the user input from being provided to the target model and implementing a mitigation process based on the user input. When the anomaly score is below the predetermined threshold, the instructions cause the device to perform operations including providing the user input to the target model and generating, by the target model, a responsive output based on the user input.

Furthermore, in the following, various embodiments are described with respect to methods and systems for input mitigation. In various embodiments, an input intended for an automated system, such as an automated interaction system, is received. An anomaly score of the input with respect to the automated system is determined. The anomaly score represents a likelihood of an input being in- or out-of-distribution for a set of typical or expected inputs based on, for example, a difference (e.g., distance) between the input and the set of expected inputs (e.g., an input distribution) to the corresponding automated system. The anomaly score may be determined based on one or more measures, such as the perplexity of the input (e.g., the exponentiated average negative log-likelihood of a sequence for the input), a classification of the input, a reasoning for classification of the input, etc. In some embodiments, a high anomaly score indicates a malicious, unrecognized, or otherwise unexpected input, e.g., an out-of-distribution input. Correspondingly, a low anomaly score indicates an expected input, e.g., an in-distribution input. When the anomaly score of the input is determined to be below a predetermined threshold, the input may be provided to the corresponding automated system for processing. In some embodiments, the anomaly score is provided with the input to indicate to the automated system that the input is safe to process. Alternatively, when the anomaly score of the input is determined to be greater than or equal to the predetermined threshold, the input may be provided for mitigation.

Input mitigation may include altering the input before providing it to the automated system, providing the input to an alternative system, directing a user to an alternative process or interaction channel, preventing the input from being provided to the automated system, etc. In response to performing mitigation, a modified or mitigated input may be provided to the intended automated system for processing. Alternatively, in response to performing mitigation, the input may be routed to an alternative interaction or processing channel or may be discarded.

In some embodiments, systems, and methods for input mitigation include one or more trained or tuned models. The models may include one or more LLMs fine-tuned on a representative sampling of expected behavior to improve the effectiveness of determining the likelihood of an input being in-distribution, e.g., determining an out-of-distribution score. The out-of-distribution score may be used by the fine-tuned LLM to determine how in- or out-of-distribution the received input is for the expected range of inputs for the corresponding automated system. In some embodiments, the out-of-distribution score may include a perplexity score for the input. The fine-tuned LLM may initiate one or more mitigation processes based on the anomaly score of the input. As another example, the models may include one or more mitigation models configured to implement one or more mitigation processes, such as modifying an input, extracting usable information from an input, etc.

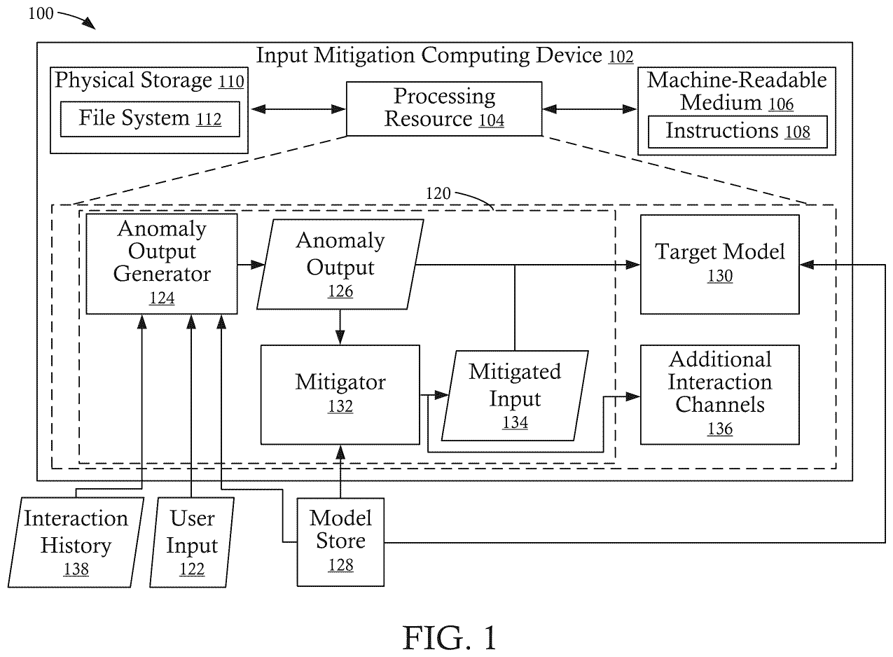

FIG. 1 depicts an example system 100 that provides input mitigation, in accordance with some embodiments. The system 100 includes an input mitigation computing device 102 that prevents harmful or undesirable inputs from reaching one or more automated systems, such as interaction models. The input mitigation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The input mitigation computing device 102 includes a non-transitory machine-readable medium 106 that may include one or more of a random access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine-readable medium 106 to perform functions of the input mitigation computing device 102, such as receiving an input intended for an automated system (e.g., an interaction system), determining an anomaly score of the input, determining whether to provide the input to the automated system based on the anomaly score, and implementing one or more mitigation processes to mitigate harmful or unintended inputs. The instructions 108 may include instructions for implementing one or more models. In some embodiments, and as will be described further herein below, the input mitigation computing device 102 may execute one or more models, processes, or algorithms, such as a machine learning model, deep learning model, statistical model, etc. (e.g., as implemented as machine-readable instructions) to determine an anomaly score of an input, implement one or more mitigation processes, or implement one or more user interaction processes.

The input mitigation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the input mitigation computing device 102. In some implementations, physical storage 110 may be accessed as a block storage device.

In some cases, the input mitigation computing device 102 may also include a local file system 112 that may be implemented as a layer on top of the physical storage 110. For example, an operating system may be executing on the input mitigation computing device 102 (by virtue of the processing resource 104 executing certain instructions 108 related to the operating system) and the operating system may provide a file system 112 to store data on the physical storage 110.

The input mitigation computing device 102 may be in communication with one or more additional devices over one or more network channels. For example, in various embodiments, the input mitigation computing device 102 may be in communication with a web server, a cloud-based engine including one or more processing devices that may be provisioned for use, a database, a workstation, and/or any other suitable system or device. The input mitigation computing device 102 may similarly be in communication, either directly or indirectly, with one or more user computing devices operatively coupled over the network. The other computing systems may be similar to the input mitigation computing device 102, and may each include at least a processing resource and a machine-readable medium.

The input mitigation computing device 102, such as the processing resource 104, implements an input mitigation process 120. The input mitigation process 120 receives a user input 122 intended for an automated system or process, e.g., a target model 130, that receives user inputs and generates responsive outputs (e.g., a generative model, a trained interaction model, etc.). The user input 122 may include a user prompt, a user utterance, a user selection, a user response, or any other suitable input intended for the target model 130. In some embodiments, the target model 130 includes a generative model that provides one or more simulated roles for interacting with users, such as a chatbot (e.g., a customer service chatbot, a sales chatbot, etc.). The user input 122 may be received via any suitable interface, such as a user interface generated on a corresponding user device, a spoken user input generated and received via one or more transcription and natural language recognition processes, a visual input obtained via one or more image input processes, etc.

In some embodiments, the user input 122 is received by an anomaly output generator 124 that generates an anomaly output 126 including an anomaly score for the received user input 122. An anomaly score represents a likelihood of the user input 122 being in-distribution as compared to an expected distribution of inputs for the corresponding target model 130. For example, where the target model 130 is a customer service chatbot, the expected distribution of inputs includes a set of expected customer service tasks, such as inputs regarding returns, item inquiries, hours for physical locations, and other common customer service inquiries. A user input 122 that is similar to or within this distribution of inputs may have a low anomaly score. In contrast, a user input 122 that is outside of the expected distribution, such as malicious inputs related to intentionally harmful attacks (e.g., jailbreak attempts, prompt injections attacks) or undesired inputs related to out-of-bounds topics or inquiries (e.g., off-topic conversations outside the scope of the chatbot interaction), may have a higher anomaly score.

In some embodiments, the expected distribution of inputs for the target model 130 includes an expected distribution of tokens included in expected inputs for the target model 130. For example, elements of an input, such as words, phrases, etc., may be tokenized by one or more tokenization processes. The distribution of expected tokens may be representative of concepts, inquiries, responses, or other elements that are expected as part of an interaction between a user and the corresponding target model 130. To continue the example from above, the distribution of expected tokens for a customer service chatbot may include tokens representative of customer service concepts, tokens representative of types of customer information, tokens representative of specific interactions (e.g., returns, purchases, requests for information), etc. As used herein, a distribution of expected inputs includes a distribution of expected input tokens for a corresponding target model 130.

In some embodiments, the anomaly output generator 124 generates an anomaly output 126 including an anomaly score and, optionally, one or more anomaly attributes, one or more reasons for generating the anomaly score, or any other suitable output. For example, the anomaly output 126 may include an overall anomaly score indicating whether the received user input 122 is within an expected distribution of inputs for the target model 130 (e.g., the user input 122 is within an expected range of inputs or topics for an interactive chatbot model) or is outside of the expected distribution. The anomaly output 126 may further include one or more attributes related to the anomaly score and indicative of one or more reasons for the anomaly score. For example, in response to the anomaly score less than (or less than or equal to in some embodiments) a predetermined threshold (e.g., within an expected distribution of inputs), the anomaly output 126 may include an anomaly attribute indicating similarity of the user input 122 to one or more known expected inputs. Similarly, in response to the anomaly score greater than or equal to (or greater than in some embodiments) a predetermined threshold (e.g., outside an expected distribution of inputs), the anomaly output 126 may include an anomaly attribute indicating a suspected type of out of distribution input, e.g., a prompt injection attack, a jailbreak attempt, an off-topic conversation input, etc.

In some embodiments, the anomaly output generator 124 implements one or more trained or fine-tuned models to identify out of distribution user inputs 122, e.g., user inputs having high anomaly score values. The implemented models may be received from a model store 128 in the form of model parameters, fine-tuning prompts, etc. In some embodiments, the anomaly output generator 124 implements an LLM to determine the anomaly score of a user input 122.

In some embodiments, in response to determining the user input 122 is within an expected distribution, e.g., in response to the anomaly score being less than a predetermined threshold, the input mitigation process 120 forwards the user input 122 and, optionally, the anomaly output 126 to the target model 130. The target model 130 receives the user input 122 and executes one or more processes in response to receiving the user input 122 to generate and provide an output. From a user viewpoint, the user input 122 is simply received by the target model 130, and a response is provided. In some embodiments, the target model 130 verifies the anomaly output 126 (e.g., by comparing the anomaly score to the predetermined threshold) prior to processing the user input 122.

In some embodiments, in response to determining the user input 122 is outside of an expected distribution, e.g., in response to the anomaly score being greater than or equal to a predetermined threshold, the user input 122 and, optionally, the anomaly output 126, are provided to a mitigator 132 that implements one or more mitigation processes for the corresponding user input 122. The one or more mitigation processes implemented by the mitigator 132 may be responsive to a type of out of distribution input received in the user input 122. As one example, in response to the user input 122 being a jailbreak attempt, a jailbreak mitigation process may be implemented that prevents transmission of the user input 122 to the target model 130, and either provides an alternative input to the target model 130 (e.g., an input that causes an interaction model to generate an output asking for a different input or indicating that the prior input is not acceptable) or directs a user to an additional interaction channel 136 (e.g., an alternative interaction channel), as discussed below. As another example, in response to the user input 122 being an off-topic discussion, an off-topic mitigation process may be implemented to substitute an input for user input 122 that causes the target model 130 to output a response requesting a user to stay on topic or indicating the prior user input 122 was outside the scope of the target model 130. It will be appreciated that any number of mitigation processes responsive to any type of identified out of distribution input may be implemented.

In some embodiments, the mitigator 132 generates a mitigated input 134. The mitigated input 134, and, optionally, the anomaly output 126, may be provided to the target model 130. The mitigated input 134 may include a modified version of the user input 122 or a substitute input. For example, in response to the user input 122 including both undesirable inputs (e.g., off-topic conversations) and desired inputs (e.g., on-topic responses), the mitigated input 134 may be generated by removing the undesirable portions of the user input 122 while retaining the desired inputs. As another example, in response to the user input 122 including only undesirable inputs (e.g., only off-topic conversations), the mitigated input 134 may include a substituted input that causes the target model 130 to generate an output reiterating a previous prompt or indicating that the received input is outside the scope of the target model 130.

In some embodiments, in response to the mitigator 132 determining that the user input 122 cannot or should not be mitigated (e.g., in the case of an intentionally harmful input such as a jailbreak or prompt injection attempt), the mitigator 132 may filter the user input 122 to one or more additional interaction channels 136. For example, in response to determining that the user input 122 is an intentionally malicious input (e.g., a prompt injection attack), the mitigator 132 may route the user input 122, and the user interaction generally, to an alternative interaction channel such as a live (e.g., human-operated) chat, a voice system, etc. By routing users providing intentionally malicious inputs to live or alternative interaction channels, the mitigator 132 prevents the malicious actor from having additional opportunities to attempt to provide a malicious input to the target model 130. In some embodiments, a mitigated input 134 may be generated and provided to the target model 130 to cause the target model 130 to generate an output indicating that the user is being routed to an alternative interaction channel or to provide instructions for the user to access the alternative interaction channel. In some embodiments, a mitigated input 134 includes instructions for transferring an interaction from the target model 130 to one or more additional interaction channels 136 and may be provided to corresponding additional interaction channels 136.

In some embodiments, the mitigator 132 attempts a predetermined quantity of mitigations before routing a user interaction to one or more additional interaction channels 136. For example, the mitigator 132 may generate a mitigated input 134 for each first instance of a user input 122 having a high anomaly score during an interaction. The mitigated input 134 may include a modified version of the user input 122, when appropriate, or may include a substitute user input that causes the target model 130 to generate an output requesting a different input. As one non-limiting example, in response to a user input 122 including a prompt injection attempt that has a high anomaly score (e.g., is out of distribution for the expected range of inputs to the target model 130), the mitigator 132 may generate a mitigated input 134 that causes the target model 130 to generate an output indicating the received user input 122 (e.g., the prompt injection attack) is not an acceptable input to the target model 130 and requesting a suitable input within the scope of the target model 130. A second user input 122 may subsequently be received. In response to determining that the second user input 122 has a high anomaly (e.g., is a second prompt injection attack or other malicious input), the mitigator 132 may route the user to one or more additional interaction channels 136 to prevent additional malicious inputs from being received.

In some embodiments, the mitigator 132 implements one or more trained or fine-tuned models to identify or mitigate one or more user inputs 122, e.g., user inputs 122 having high anomaly scores. The implemented models may be received from a model store 128 in the form of model parameters, fine-tuning prompts, etc. In some embodiments, the mitigator 132 implements an LLM to execute one or more mitigation processes.

The input mitigation process 120 may be implemented for each input received from a user device during an interaction with a target model 130. For example, an interaction with a target model 130, such as an interactive chatbot, may consist of multiple turns during which a first actor, such as the interactive chatbot, provides a prompt or request and receives a response from a second actor, such as a user device. For each turn, a user input 122 may be received from a user device and may be processed by an anomaly output generator 124 to identify whether the corresponding user input 122 is in distribution or out of distribution for an expected set of input for the corresponding target model 130.

In some embodiments, the anomaly output generator 124 receives interaction history 138 for the current user-model interaction and determines the distribution of expected inputs based, at least in part, on the interaction history 138. For example, when a user input 122 is received during a second turn of an interaction, the anomaly output generator 124 may additionally receive interaction history 138 including a transcript of the first turn and, when present, a prompt generated by the target model 130 for the second turn. The anomaly output generator 124 may limit the distribution of expected inputs to inputs expected for the specific corresponding prompt and/or based on the interaction history 138.

In some embodiments, in-distribution inputs or out-of-distribution inputs that have been mitigated and corresponding outputs of the target model 130 may be used for additional tasks, such as persona simulation for model testing, training of automated or human agents, re-training of anomaly output determination models, etc. The in-distribution inputs, out-of-distribution inputs that have been mitigated, and/or initial out-of-distribution inputs and corresponding outputs of the target model 130 may be stored in one or more data stores.

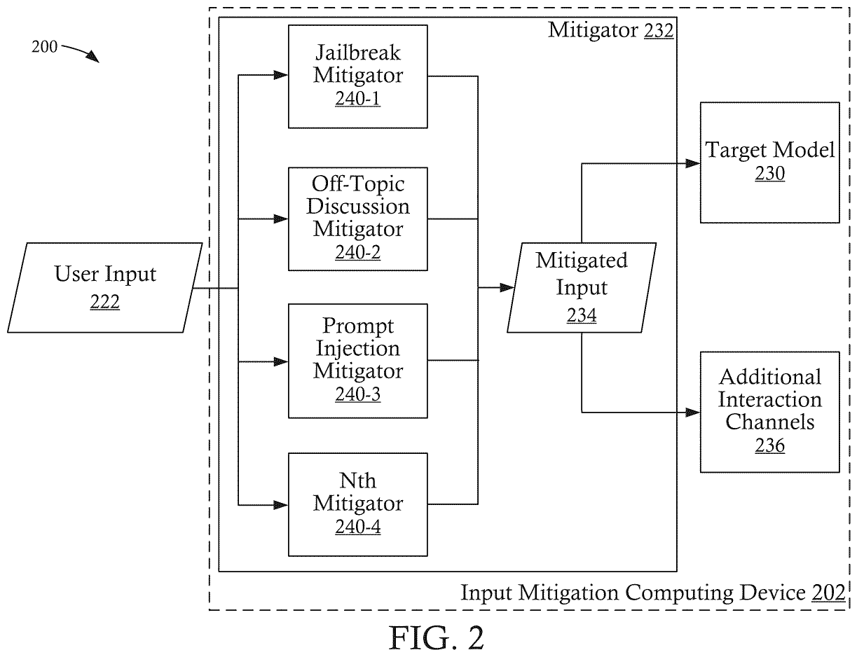

FIG. 2 depicts an example system 200 for implementing a plurality of mitigation processes, in accordance with some embodiments. The system 200 may include an input mitigation computing device 202 similar to the input mitigation computing device 102 discussed above with respect to FIG. 1. A processing resource of the input mitigation computing device 202 may implement a mitigator 232, for example, as part of an input mitigation process 120 as discussed above with respect to FIG. 1.

The mitigator 232 may include one or more mitigation processes, such as a jailbreak process 240-1, an off-topic discussion process 240-2, a prompt injection process 240-3, and an Nth process 240-4 (representative of one or more additional mitigation processes) (collectively referred to herein as “mitigation processes 240”). Each of the mitigation processes 240 receives a user input 222 and implements a corresponding detection and mitigation process based on the received user input 222. The user input 222 may be received from an anomaly output determination process, such as a process implemented by the anomaly score generator 124 of FIG. 1, and may, optionally, include an anomaly score or anomaly determination.

Each of the mitigation processes 240 may implement an input-specific detection and mitigation process. As one non-limiting example, the mitigator 232 includes a jailbreak process 240-1 that determines whether the user input 222 is a jailbreak attempt. In response to determining the user input 222 is not a jailbreak attempt, the jailbreak process 240-1 may terminate. Alternatively, in response to determining the user input 222 is a jailbreak attempt, the jailbreak process 240-1 generates a corresponding mitigated input 234, such as a substitute input that causes a target model 230 to generate an output indicating a user is being transferred to one or more additional interaction channels 236 and subsequently transfers the user to the corresponding one or more additional interaction channels 236.

As another non-limiting example, the mitigator 232 includes an off-topic discussion process 240-2 that determines whether the user input 222 is an input containing an off-topic request or response. In response to determining the user input 222 is not an off-topic input, the off-topic discussion process 240-2 may terminate. Alternatively, in response to determining the user input 222 is an off-topic input, the off-topic discussion process 240-2 generates a corresponding mitigated input 234 that includes on-topic elements of the user input 222 (when present) and/or causes a target model 230 to generate an output indicating the received user input 222 is off topic and providing (or reiterating) a request for an on-topic input.

As still another non-limiting example, the mitigator 232 includes a prompt injection process 240-3 that determines whether the user input 222 is an attempted prompt injection attack. In response to determining the user input 222 is not a prompt injection attack, the prompt injection process 240-3 may terminate. Alternatively, in response to determining the user input 122 is a prompt injection attack, the prompt injection process 240-3 generates a corresponding mitigated input 234 that routes a user interaction to one or more additional interaction channels 236 and terminates the interaction with the target model 230. Although various embodiments are discussed herein, it will be appreciated that the mitigation processes 240 may include any suitable mitigation process and generate any corresponding mitigated input 234.

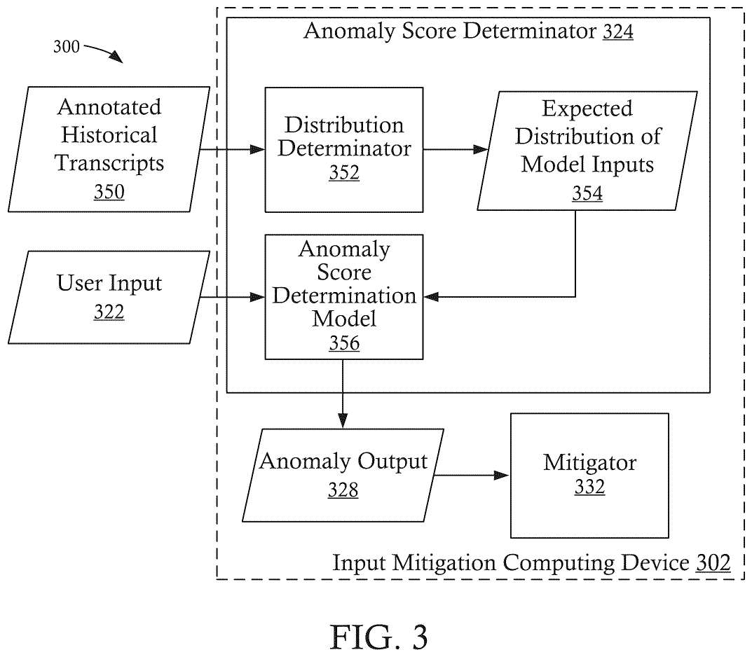

FIG. 3 depicts an example system 300 for generating an anomaly determination 328 for a user input 322, in accordance with some embodiments. The system 300 may include an input mitigation computing device 302 similar to the input mitigation computing device 102 discussed above with respect to FIG. 1. A processing resource of the input mitigation computing device 302 may implement an anomaly score determinator 324, for example, as part of an input mitigation process 120 as discussed above with respect to FIG. 1.

The anomaly score determinator 324 includes a distribution determinator 352 that receives a set of annotated historical transcripts 350 and generates an expected distribution of model inputs 354 for a corresponding target model, such as target model 130 discussed above with respect to FIG. 1. The set of annotated historical transcripts 350 may include prior interaction transcripts for the corresponding target model, prior transcripts for one or more other trained models, and/or prior transcripts for one or more human-led interactions, such as one or more chat logs or transcriptions of telephonic conversations. The set of annotated historical transcripts 350 may include annotations indicating whether a received input (e.g., an utterance, a response, a prompt, etc.) received from a user (or user device) was expected or unexpected with respect to the scope of the interaction or the prior interaction history. In some embodiments, the set of annotated historical transcripts 350 includes transcripts containing only expected (e.g., in-distribution) responses and interactions.

In some embodiments, the set of annotated historical transcripts 350 includes user inputs identified as having a low anomaly score by one or more prior instances of an anomaly score determination model, e.g., one or more prior instances of anomaly output determination model 356. For example, a first anomaly output determination model may be generated for an expected range of inputs for a first target model. The first anomaly score determination model may identify a set of expected inputs. Subsequently, a second anomaly score determination model may be generated for an expected range of inputs for the first target model or a second target model that is similar to the first target model based on the set of inputs indicated as having a low perplexity by the first anomaly score determination model.

In some embodiments, the expected distribution of model inputs 354 is representative of one or more statistical elements of expected inputs based on the set of annotated historical transcripts 350. For example, the expected distribution of model inputs 354 may include semantic elements or statistics representative of semantic similarities between the set of expected inputs as determined by the distribution determinator 352 based on the set of annotated historical transcripts 350. The expected distribution of model inputs 354 may be provided in any format that may be used to train or tune (e.g., fine-tune) an anomaly output determination model 356 as discussed in greater detail below. For example, the expected distribution of model inputs 354 may be provided as statistics and/or values for adjusting a trained model. As another example, the expected distribution of model inputs 354 may include example expected inputs for fine-tuning an LLM via one or more prompts.

The expected distribution of model inputs 354 are provided for training or tuning of the anomaly output determination model 356. In some embodiments, the anomaly output determination model 356 includes an LLM that receives the expected distribution of model inputs 354 and is semantically and/or statistically tuned based on the expected distribution of model inputs 354 to be specific to a distribution of inputs for one or more target models. As another example, in some embodiments, the anomaly output determination model 356 may receive the expected distribution of model inputs 354 and implement one or more re-training processes to modify the anomaly output determination model 356 to incorporate or utilize the expected distribution of model inputs 354.

After the anomaly output determination model 356 is modified based on the expected distribution of model inputs 354 for a corresponding target model, a user input 322 intended for the corresponding target model is received. The anomaly output determination model 356 determines whether the user input 322 is in distribution with respect to expected distribution of model inputs 354 and generates an anomaly output 328. The anomaly output 328 may include an anomaly score indicative of a predicted position of the user input 322 within a distribution for the expected distribution of model inputs 354. A low anomaly score (e.g., an anomaly score less than a predetermined threshold) may correspond to a user input 322 that falls within the expected distribution of model inputs 354 (e.g., an in-distribution input) and a high anomaly score (e.g., an anomaly score greater than or equal to the predetermined threshold) may correspond to a user input 322 that is outside of the expected distribution of model inputs 354 (e.g., an out of distribution input).

In some embodiments, the anomaly output determination model 356 may generate a type identifier for an expected type for the user input 322. For example, type identifiers may include an in-distribution identifier (e.g., an identifier indicating a user input 322 having a low perplexity is expected to be an in-distribution input) or one or more out of distribution identifiers (e.g., one or more identifiers indicating a user input 322 having a high anomaly score is expected to be one of a plurality of potential out-of-distribution inputs, such as a jailbreak attempt indicator, a prompt injection indicator, an off-topic discussion indicator, etc.). In some embodiments, a type identifier is omitted, and a type determination may be performed by one or more elements of a mitigator 332, for example, as discussed above with respect to FIG. 2.

In response to the anomaly output 328 indicating an out-of-distribution user input, the anomaly output 328 and/or the user input 322 may be provided to a mitigator 332. The mitigator 332 may utilize the anomaly output 328 and/or the user input 322 to generate a mitigated input or to route a user interaction to one or more alternative interaction channels, as discussed above with respect to FIGS. 1 and 2. In some embodiments, the mitigator 332 selects a mitigation process that corresponds to an expected type identifier of an out of distribution user input 322 included in the anomaly output 328.

In some embodiments, the anomaly output determination model 356 may generate an anomaly output 328 including reasoning and/or justifications for the anomaly score generated for the user input 322, e.g., may include a response to a query such as “why is the input unexpected?” In some embodiments, the anomaly output 328 includes to a classification of the user input 322 into one or more out-of-distribution topics (e.g., harmful content, bias, violence, prompt injection), one or more in-distribution topics (e.g., spoiled food, late delivery), and/or any other suitable output. The anomaly output determination model 356 provides a flexible structure that can provide additional outputs or functionality that enable generation and utilization of additional outputs to determine mitigation processes and/or identify unexpected or expected inputs. For example, in some embodiments, an anomaly score based on perplexity, a classification of an input, and a justification for the classification may each be used to determine a mitigation process to be applied to the user input 322.

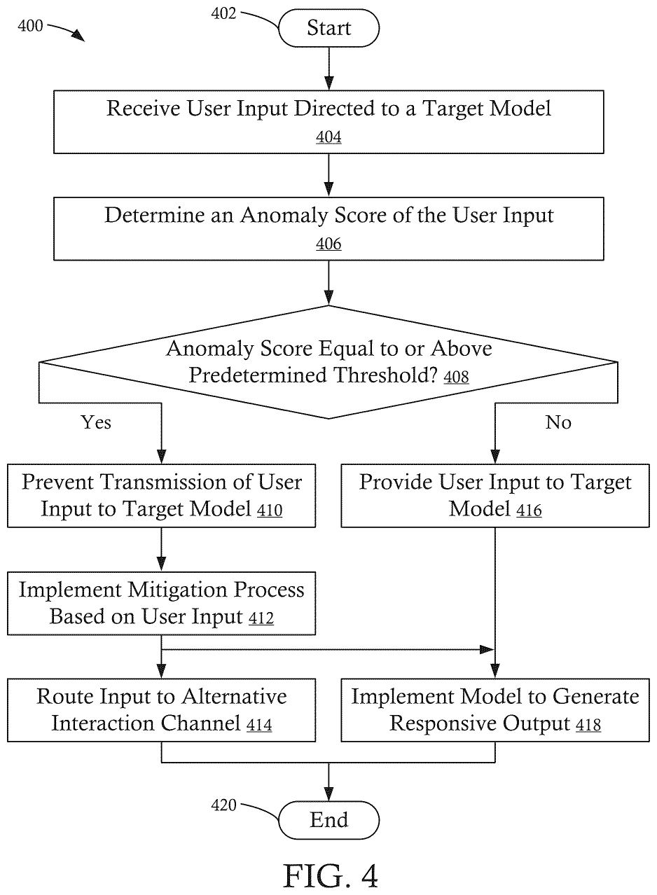

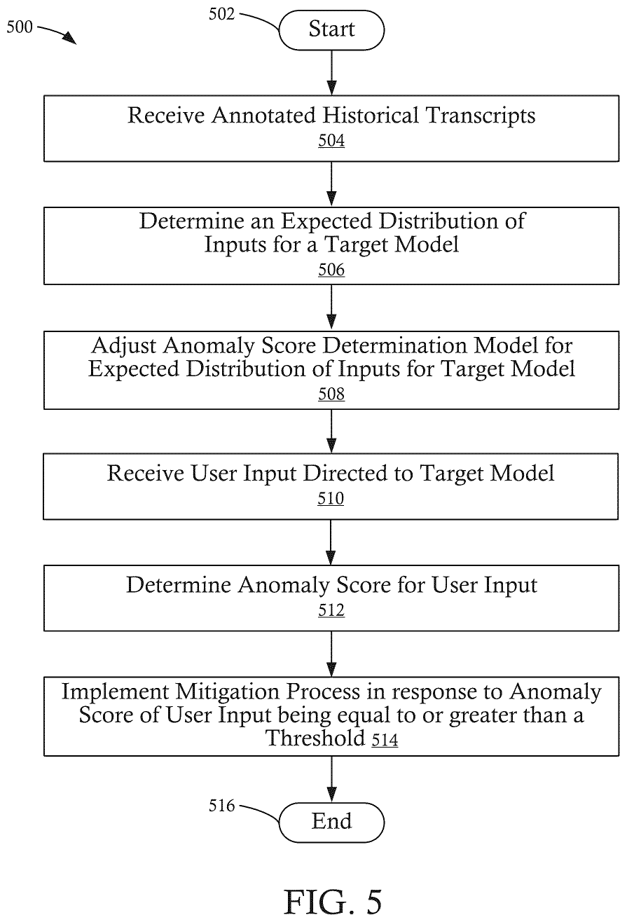

FIGS. 4 and 5 are flow diagrams depicting example methods. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 4 and 5 may be implemented in the form of executable instructions stored on a machine-readable medium and executed by a processing resource and/or in the form of electronic circuitry. For example, aspects of the method may be described below as being performed by a mitigation process, an example of which may be the input mitigation process 120 running on a hardware processing resource 104 of the input mitigation computing device 102 described above. Additionally, other aspects of the method described below may be described with reference to other elements shown in FIG. 1 for non-limiting illustration purposes.

FIG. 4 depicts a flowchart of an example method 400 for mitigating inputs to a target model, in accordance with some embodiments. Method 400 starts at block 402 and continues to block 404, where a user input intended for (e.g., directed to) a target model is received. The user input may be an initial input or a responsive input intended for a target model, such as a chatbot or other interactive model. The user input may be a first input received or may be a subsequent input received as part of an on-going interaction (e.g., ongoing conversation) with the target model. The user input may be received from any suitable system, such as a user device, web server, etc.

At block 406, an anomaly score for the user input is determined. The anomaly score for the user input is representative of a position of the received user input with respect to a distribution of expected inputs for the corresponding target model. A user input that falls within the distribution of expected inputs may have a low anomaly score (e.g., may have an anomaly score less than a predetermined threshold). In contrast, a user input that falls outside of the distribution of expected inputs may have a high anomaly score (e.g., may have an anomaly score greater than or equal to a predetermined threshold). The anomaly score may be determined by one or more trained and/or tuned models, such as an LLM fine-tuned to semantically parse a user input to identify a similarity to an expected set of user inputs for a corresponding target model. In some embodiments, the anomaly score includes a perplexity score for an input.

At block 408, a determination is made whether the anomaly score is greater than or equal to a predetermined threshold. In response to determining the anomaly score is greater than or equal to the predetermined threshold, the method 400 proceeds to block 410 and transmission of the user input to the target model is prevented. At block 412, a mitigation process is implemented based on the user input. The mitigation process attempts to generate a mitigated input for the corresponding target model. In response to determining that a mitigated input cannot be generated (for example, where the user input includes only a malicious input), the method 400 optionally proceeds to block 414 and routes the user interaction corresponding to the user input to one or more alternative interaction channels. In some embodiments, block 414 may be omitted and the method 400 may proceed to block 420 and end in response to determining a mitigated input cannot be generated (e.g., no additional actions are taken by the mitigation system or the target model when a mitigated input cannot be generated). In response to generating a mitigated user input, the mitigated user input may be provided to the target model, which, at block 418, is implemented to generate a responsive output.

In response to determining, at block 408, that the anomaly score is less than the predetermined threshold, the method 400 proceeds to block 416 and the user input is provided to the target model. The method 400 proceeds to block 418 and the target model is implemented to generate a responsive output. After implementing the target model at block 418, the method 400 proceeds to block 420, and the method 400 ends.

FIG. 5 depicts a flowchart of an example method 500 for implementing an anomaly score determination model for a target model, in accordance with some embodiments. The method 500 begins at block 502 and continues to block 504, where annotated (and optionally anonymized) historical transcripts of prior interactions are received. The annotated historical transcripts may include prior interaction transcripts for the corresponding target model, prior transcripts for one or more other related or similar models, and/or prior transcripts for one or more human-led interactions, such as one or more chat logs or transcriptions of telephonic conversations. The annotated historical transcripts may include annotations indicating whether an input (e.g., an utterance, a response, a prompt, etc.) received from a user (or user device) was expected or unexpected with respect to the scope of the interaction or the prior interaction history. In some embodiments, the annotated historical transcripts include transcripts containing only expected responses and interactions.

At block 506, an expected distribution of inputs for the target model is generated from the annotated historical transcripts. The expected distribution of inputs for the target model may include a distribution representative of one or more statistical elements of expected inputs based on the annotated historical transcripts. As another example, the expected distribution of inputs for the target model may include a semantically representative set of expected inputs for the target model. The expected distribution of inputs may be provided as statistics and/or values for adjusting a trained model. As another example, the expected distribution of inputs may include example expected inputs for fine-tuning an LLM via one or more prompts.

At block 508, an anomaly score determination model is adjusted, or tuned, based on the expected distribution of inputs for the corresponding target model. The anomaly score determination model may be adjusted by training or modifying a preexisting model. For example, an anomaly score determination model may include an LLM that receives the expected distribution of inputs and is semantically and/or statistically tuned based on the expected distribution of inputs to be specific to the target model. As another example, in some embodiments, an anomaly score determination model may receive the expected distribution of model inputs and implement one or more re-training processes to modify the anomaly score determination model to incorporate or utilize the expected distribution of inputs.

At block 510, a user input intended for (e.g., directed to) the corresponding target model is received and, at block 512, an anomaly score of the received user input is determined. For example, an anomaly score determination model may determine whether the user input is in-distribution with respect to expected distribution of inputs or out of distribution and generate an anomaly output including an anomaly score. An anomaly score may include or be based on a perplexity score indicative of the perplexity of the user input. A low anomaly score may correspond to a user input that falls within the expected distribution of inputs and a high anomaly score may correspond to a user input that is outside of the expected distribution of inputs.

At block 514, and in response to the anomaly score determination at block 512 indicating an out of distribution user input, the anomaly output and/or the user input may be provided to a mitigator. The mitigator may utilize the anomaly output and/or the user input to generate a mitigated input or to route a user interaction to one or more alternative interaction channels, as discussed above with respect to FIGS. 1 and 2. At block 516, the method 500 ends.

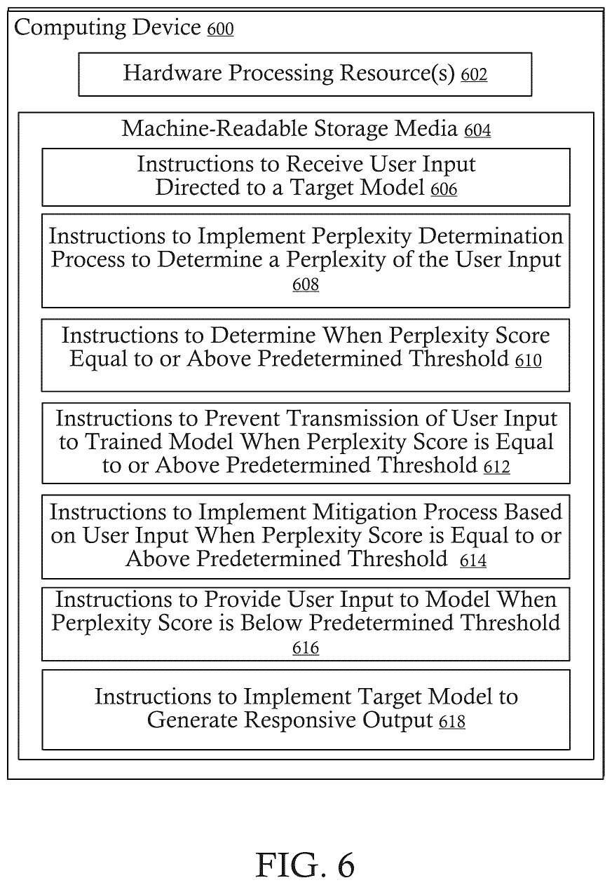

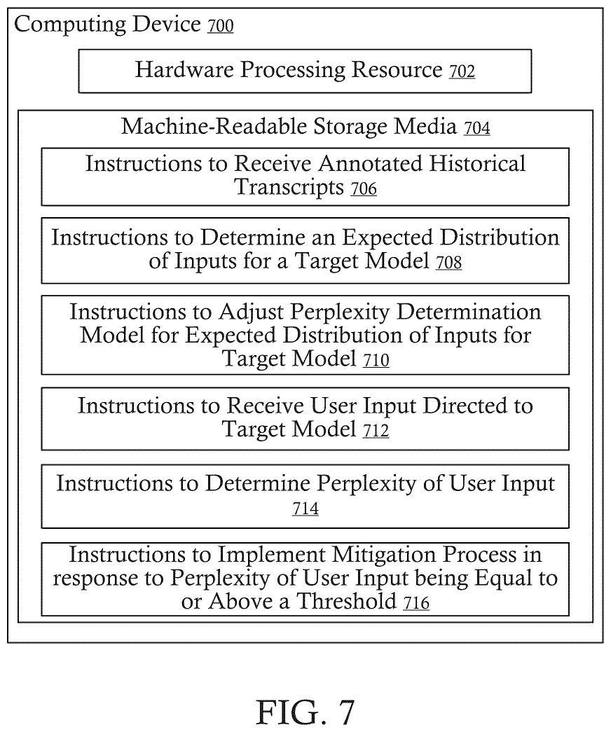

FIGS. 6 and 7 depict example systems 600, 700 that include a machine-readable storage media 604, 704 encoded with example instructions executable by processing resource 602, 702. In some implementations the systems 600, 700 may be useful for implementing aspects of the system 100 of FIG. 1 or performing the aspects of methods 400, 500 of FIGS. 4 and 5. For example, the instructions encoded on machine-readable storage media 604, 704 may be included in instructions 108 of FIG. 1. In some implementations, functionality described with respect to FIG. 1 may be included in the instructions encoded on machine-readable storage media 604, 704.

The processing resource 602, 702 may include a microcontroller, a microprocessor, central processing unit core(s), an ASIC, an FPGA, and/or other hardware device suitable for retrieval and/or execution of instructions from the machine-readable storage media 604, 704 to perform functions related to various examples. Additionally or alternatively, the processing resource 602, 702 may include or be coupled to electronic circuitry or dedicated logic for performing some or all of the functionality of the instructions described herein.

The machine-readable storage media 604, 704 may be any medium suitable for storing executable instructions, such as RAM, ROM, EEPROM, flash memory, a hard disk drive, an optical disc, or the like. In some example implementations, the machine-readable storage media 604, 704 may be a tangible, non-transitory medium. The machine-readable storage media 604, 704 may be disposed within a corresponding system 600, 700 in which case the executable instructions may be deemed installed or embedded on the system. Alternatively, the machine-readable storage media 604, 704 may be a portable (e.g., external) storage medium, and may be part of an installation package.

As described further herein below, the machine-readable storage media 604, 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIGS. 6 and 7.

As shown in FIG. 6, the machine-readable storage media 604 includes instructions 606-618. Instructions 606, when executed, cause the processing resource 602 to receive a user input directed to a target model. The user input may be an initial input or a responsive input intended for an interaction model, such as a chatbot or other interactive model. The user input may be a first input received or may be a subsequent input received as part of an ongoing interaction with the target model. The user input may be received from any suitable system, such as a user device, web server, etc.

Instructions 608, when executed, cause the processing resource 602 to determine an anomaly score of the user input. The anomaly score of the user input is representative of a position of the received user input with respect to a distribution of expected inputs for the corresponding target model. A user input that falls within the distribution of expected inputs may have a low anomaly score. In contrast, a user input that falls outside of the distribution of expected inputs may have a high anomaly score. The anomaly score may be determined by one or more trained and/or tuned models, such as an LLM fine-tuned to semantically parse a user input to identify a similarity to an expected set of user inputs for a corresponding target model.

Instructions 610, when executed, cause the processing resource 602 to determine when the anomaly score is greater than or equal to a predetermined threshold. Instructions 612, when executed, cause the processing resource 602, in response to determining the anomaly score is greater than or equal to the predetermined threshold, to prevent transmission of the user input to the target model. Instructions 614, when executed, cause the processing resource 602, in response to determining the anomaly score is greater than or equal to the predetermined threshold, to implement a mitigation process based on the user input. The mitigation process attempts to generate a mitigated input for the corresponding target model.

Instructions 616, when executed, cause the processing resource 602, in response to determining the anomaly score is less than the predetermined threshold, to provide the user input to the target model. Instructions 618, when executed, cause the processing resource 602 to implement the target model to generate a responsive output. In response to determining the anomaly score is less than the predetermined threshold, the instructions 618 may be implemented to generate an output responsive to the initial user input. Alternatively, in response to determining the anomaly score is greater than or equal to the predetermined threshold, the instructions 618 may be implemented to generate an output responsive to a mitigated user input. In some embodiments, in response to determining the anomaly score is greater than or equal to the predetermined threshold, the instructions 618 may be omitted and the target model is not implemented.

As shown in FIG. 7, the machine-readable storage media 704 includes instructions 706-716. Instructions 706, when executed, cause the processing resource 702 to receive annotated historical transcripts of prior interactions. The annotated historical transcripts may include prior interaction transcripts for the corresponding target model, prior transcripts for one or more other related or similar models, and/or prior transcripts for one or more human-led interactions, such as one or more chat logs or transcriptions of telephonic conversations. The annotated historical transcripts may include annotations indicating whether an input received from a user (or user device) was expected or unexpected with respect to the scope of the interaction or the prior interaction history. In some embodiments, the annotated historical transcripts include transcripts containing only expected responses and interactions.

Instructions 708, when executed, cause the processing resource 702 to determine an expected distribution of inputs for the target model from the annotated historical transcripts. The expected distribution of inputs for the target model may include a distribution representative of one or more statistical elements of expected inputs based on the annotated historical transcripts. As another example, the expected distribution of inputs for the target model may include a semantically representative set of expected inputs for the target model. The expected distribution of inputs may be provided as statistics and/or values for adjusting a trained model. As another example, the expected distribution of inputs may include example expected inputs for fine-tuning an LLM via one or more prompts.

Instructions 710, when executed, cause the processing resource 702 to adjust an anomaly output determination model based on the expected distribution of inputs for the corresponding target model. The anomaly output determination model may be adjusted by training or modifying a preexisting model. For example, an anomaly output determination model may include an LLM that receives the expected distribution of inputs and is semantically and/or statistically tuned based on the expected distribution of inputs to be specific to the target model. As another example, in some embodiments, an anomaly output determination model may receive the expected distribution of model inputs and implement one or more re-training processes to modify the distribution determination model to incorporate or utilize the expected distribution of inputs.

Instructions 712, when executed, cause the processing resource 702 to a receive a user input intended for the corresponding target model. Instructions 714, when executed, cause the processing resource 702 to determine an anomaly score of the received user input. For example, an anomaly output determination model may generate an anomaly output including an anomaly score representative of whether the user input is in distribution or out of distribution with respect to expected distribution of inputs. An anomaly score may include or be based on a perplexity score indicative of the perplexity of the user input. A low anomaly score may correspond to a user input that falls within the expected distribution of inputs and a high anomaly score may correspond to a user input that is outside of the expected distribution of inputs.

Instructions 716, when executed, cause the processing resource 702 to implement a mitigation process in response to the anomaly output (e.g., the anomaly score) indicating an out of distribution user input. The mitigation process may utilize the anomaly output and/or the user input to generate a mitigated input or to route a user interaction to one or more alternative interaction channels, as discussed above with respect to FIGS. 1 and 2.

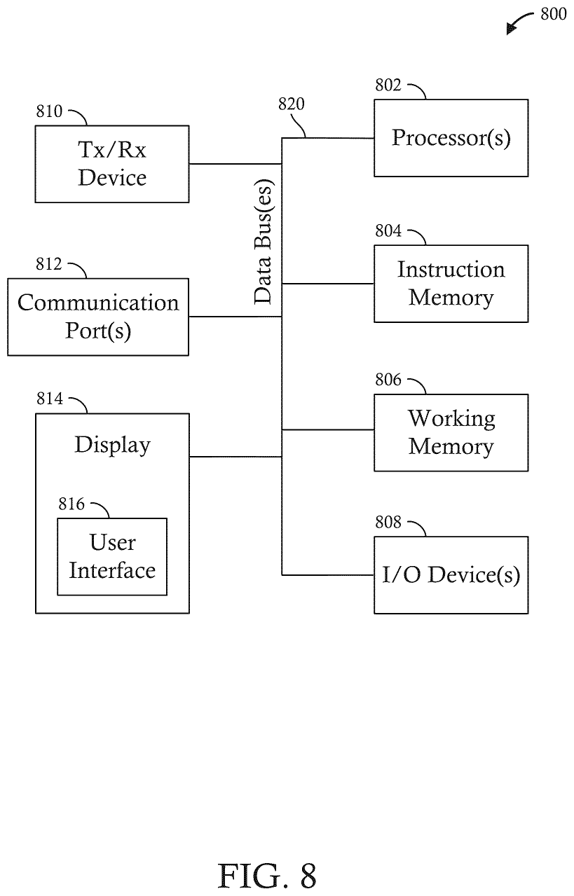

FIG. 8 illustrates a block diagram of a computing device 800, in accordance with some embodiments. Although FIG. 8 is described with respect to certain components shown therein, it will be appreciated that the elements of the computing device 800 may be combined, omitted, and/or replicated. In addition, it will be appreciated that additional elements other than those illustrated in FIG. 8 may be added to the computing device.

As shown in FIG. 8, the computing device 800 may include one or more processing resources 802, instruction memory 804, working memory 806, input/output devices 808, transceiver 810, communication port(s) 812, display 814, and/or any other suitable elements each operatively coupled to one or more data buses 820. The data buses 820 allow for communication among the various components. The data buses 820 may include wired or wireless communication channels.

The one or more processing resources 802 may include any processing circuitry operable to control operations of the computing device 800. In some embodiments, the one or more processing resources 802 include one or more distinct processors, each having one or more cores (e.g., processing circuits). Each of the distinct processors may have the same or different structure. The one or more processing resources 802 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 802 may also be implemented by a controller, a microcontroller, an application specific integrated circuit (ASIC), a field programmable gate array (FPGA), a programmable logic device (PLD), etc.

In some embodiments, the one or more processing resources 802 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 804 may store instructions that are accessed (e.g., read) and executed by at least one of the one or more processing resources 802. For example, the instruction memory 804 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 802 may perform a certain function or operation by executing code, stored on the instruction memory 804, embodying the function or operation. For example, the one or more processing resources 802 may execute code stored in the instruction memory 804 to perform one or more of any function, method, or operation disclosed herein.

Additionally, the one or more processing resources 802 may store data to, and read data from, the working memory 806. For example, the one or more processing resources 802 may store a working set of instructions to the working memory 806, such as instructions loaded from the instruction memory 804. The one or more processing resources 802 may also use the working memory 806 to store dynamic data created during one or more operations. The working memory 806 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 804 and working memory 806, it will be appreciated that the computing device 800 may include a single memory unit that operates as both instruction memory and working memory. Further, although embodiments are discussed herein including non-volatile memory, it will be appreciated that computing device 800 may include volatile memory components in addition to at least one non-volatile memory component.

In some embodiments, the instruction memory 804 and/or the working memory 806 includes an instruction set, in the form of a file for executing various methods, such as methods for mitigating harmful or out of distribution inputs for one or more target models, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 802.

The input/output devices 808 may include any suitable device that allows for data input or output. For example, the input/output devices 808 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 810 and/or the communication port(s) 812 allow for communication with a network. For example, if a communication network is a cellular network, the transceiver 810 allows communications with the cellular network. In some embodiments, the transceiver 810 is selected based on the type of communication network in which the computing device 800 will be operating. The one or more processing resources 802 are operable to receive data from, or send data to, a network, via the transceiver 810.

The communication port(s) 812 may include any suitable hardware, software, and/or combination of hardware and software that is capable of coupling the computing device 800 to one or more networks and/or additional devices. The communication port(s) 812 may be arranged to operate with any suitable technique for controlling information signals using a desired set of communications protocols, services, or operating procedures. The communication port(s) 812 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 812 allows for the programming of executable instructions in the instruction memory 804. In some embodiments, the communication port(s) 812 allow for the transfer (e.g., uploading or downloading) of data, such as machine learning model training data.

In some embodiments, the communication port(s) 812 couples the computing device 800 to a network. The network may include local area networks (LAN) as well as wide area networks (WAN) including, without limitation, the Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 810 and/or the communication port(s) 812 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 814 may be any suitable display and may display the user interface 816. For example, the user interface 816 may be a user interface for an application of a network environment operator that allows a user to view and interact with the operator's website. In some embodiments, a user may interact with the user interface 816 by engaging the input/output devices 808. In some embodiments, the display 814 may be a touchscreen, where the user interface 816 is displayed on the touchscreen.

The display 814 may include a screen such as, for example, a Liquid Crystal Display (LCD) screen, a light-emitting diode (LED) screen, an organic LED (OLED) screen, a movable display, a projection, etc. In some embodiments, the display 814 may include a coder/decoder, also known as Codecs, to convert digital media data into analog signals. For example, the visual peripheral output device may include video Codecs, audio Codecs, or any other suitable type of Codec.

In some embodiments, the computing device 800 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 800 may be a computer, a workstation, a laptop, a server such as a cloud-based server, or any other suitable device. In some embodiments, the computing device 800 is a server that includes one or more processing units, such as one or more graphical processing units (GPUs), one or more central processing units (CPUs), and/or one or more processing cores. The computing device 800 may, in some embodiments, execute one or more virtual machines. In some embodiments, processing resources (e.g., capabilities) of the computing device 800 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein as having individual, discrete systems, it will be appreciated that, in some embodiments, one or more systems may be combined into a single logical and/or physical system. Similarly, although embodiments are illustrated as having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a user input for a targeted model;
determine an anomaly score of the user input, wherein the anomaly score is representative of a similarity to expected inputs for the target model;
in response to determining the anomaly score equal to or greater than a predetermined threshold:
prevent the user input from being provided to the target model, and
implement a mitigation process based on the user input; and
in response to determining the anomaly score is less than the predetermined threshold:
provide the user input to the target model, and
generate, by the target model, a responsive output based on the user input.

2. The system of claim 1, wherein the instructions, when executed, cause the processor to determine the anomaly score of the user input at least partially based on:
receiving a set of annotated historical transcripts;
determining the expected inputs for the target model based on the set of annotated historical transcripts;
adjusting an anomaly output determination model based on the expected inputs; and
executing the anomaly output determination model to determine the anomaly score of the user input, wherein the anomaly score indicates a predicted position of the user input within an expected distribution of the expected inputs.

3. The system of claim 2, wherein:
the expected distribution of the expected inputs comprises an expected distribution of tokens included in the expected inputs for the target model; and
the expected distribution of tokens represents elements expected as part of an interaction between a user and the target model.

4. The system of claim 2, wherein adjusting the anomaly output determination model comprises:
re-training a language model included in the anomaly output determination model based on the expected distribution of the expected inputs that are specific to the target model.

5. The system of claim 1, wherein the mitigation process is implemented at least partially based on:
determining whether the user input is a jailbreak attempt; and
in accordance with a determination that the user input is a jailbreak attempt, generating a substitute input that causes the target model to generate an output indicating a user is transferred to one or more interaction channels different from the target model.

6. The system of claim 1, wherein the mitigation process is implemented at least partially based on:
determining whether the user input is an off-topic input; and
in accordance with a determination that the user input is an off-topic input, generating a corresponding mitigated input including on-topic elements of the user input, or causing the target model to generate an output indicating the user input is off topic and requesting an on-topic input.

7. The system of claim 1, wherein the mitigation process is implemented at least partially based on:
determining whether the user input is an attempted prompt injection attack; and
in accordance with a determination that the user input is an attempted prompt injection attack, generating a corresponding mitigated input that routes a user interaction to one or more additional interaction channels and terminating an interaction with the target model.

8. A computer-implemented method, comprising:
receiving a set of annotated historical transcripts;
determining a set of expected inputs for a target model based on the set of annotated historical transcripts;
adjusting an anomaly output determination model based on the set of expected inputs;
receiving a user input intended for the target model;
determining, by the anomaly output determination model, that an anomaly score of the user input is greater than or equal to a predetermined threshold, wherein the anomaly score is representative of a similarity to the set of expected inputs; and
implementing a mitigation process based on the user input including preventing the user input from being provided to the target model.

9. The computer-implemented method of claim 8, wherein adjusting the anomaly output determination model comprises:
re-training a language model included in the anomaly output determination model based on an expected distribution of the expected inputs that are specific to the target model.

10. The computer-implemented method of claim 9, wherein:
the expected distribution of the expected inputs comprises an expected distribution of tokens included in the expected inputs for the target model; and
the expected distribution of tokens represents elements expected as part of an interaction between a user and the target model.

11. The computer-implemented method of claim 8, wherein implementing the mitigation process comprises:
determining whether the user input is a jailbreak attempt; and
in accordance with a determination that the user input is a jailbreak attempt, generating a substitute input that causes the target model to generate an output indicating a user is transferred to one or more interaction channels different from the target model.

12. The computer-implemented method of claim 8, wherein implementing the mitigation process comprises:
determining whether the user input is an off-topic input; and
in accordance with a determination that the user input is an off-topic input, generating a corresponding mitigated input including on-topic elements of the user input, or causing the target model to generate an output indicating the user input is off topic and requesting an on-topic input.

13. The computer-implemented method of claim 8, wherein implementing the mitigation process comprises:
determining whether the user input is an attempted prompt injection attack; and
in accordance with a determination that the user input is an attempted prompt injection attack, generating a corresponding mitigated input that routes a user interaction to one or more additional interaction channels and terminating an interaction with the target model.

14. A non-transitory computer-readable medium having instructions stored thereon that, when executed by a processor, cause a device to perform operations comprising:
receiving a user input directed to a target model;
implementing an anomaly output determination process to determine an anomaly score for the user input, wherein the anomaly score is representative of a similarity to expected inputs for the target model;
in response to determining the anomaly score is greater than or equal to a predetermined threshold:
preventing the user input from being provided to the target model, and
implementing a mitigation process based on the user input; and
in response to determining the anomaly score is less than the predetermined threshold:
providing the user input to the target model, and
generating, by the target model, a responsive output based on the user input.

15. The non-transitory computer-readable medium of claim 14, wherein implementing the anomaly output determination process comprises:
receiving a set of annotated historical transcripts;
determining the expected inputs for the target model based on the set of annotated historical transcripts;
adjusting an anomaly output determination model based on the expected inputs; and
executing the anomaly output determination model to determine the anomaly score of the user input, wherein the anomaly score indicates a predicted position of the user input within an expected distribution of the expected inputs.

16. The non-transitory computer-readable medium of claim 15, wherein adjusting the anomaly output determination model comprises:
re-training a language model included in the anomaly output determination model based on the expected distribution of the expected inputs that are specific to the target model.

17. The non-transitory computer-readable medium of claim 15, wherein:
the expected distribution of the expected inputs comprises an expected distribution of tokens included in the expected inputs for the target model; and
the expected distribution of tokens represents elements expected as part of an interaction between a user and the target model.

18. The non-transitory computer-readable medium of claim 14, wherein implementing the mitigation process comprises:
determining whether the user input is a jailbreak attempt; and
in accordance with a determination that the user input is a jailbreak attempt, generating a substitute input that causes the target model to generate an output indicating a user is transferred to one or more interaction channels different from the target model.

19. The non-transitory computer-readable medium of claim 14, wherein implementing the mitigation process comprises:
determining whether the user input is an off-topic input; and
in accordance with a determination that the user input is an off-topic input, generating a corresponding mitigated input including on-topic elements of the user input, or causing the target model to generate an output indicating the user input is off topic and requesting an on-topic input.

20. The non-transitory computer-readable medium of claim 14, wherein implementing the mitigation process comprises:
determining whether the user input is an attempted prompt injection attack; and
in accordance with a determination that the user input is an attempted prompt injection attack, generating a corresponding mitigated input that routes a user interaction to one or more additional interaction channels and terminating an interaction with the target model.
